(19) United States
(12) Patent Application Publication
(10) Pub. No.: US 2012/0155740 A1
(43) Pub. Date: Jun. 21, 2012

(54) METHOD OF DETECTING DEFECT IN PATTERN AND APPARATUS FOR PERFORMING THE SAME

(75) Inventors: Yong-Min CHO, Suwon-si (KR); Jin-Seo CHOI, Hwaseong-si (KR); Dong-Ryul LEE, Suwon-si (KR)

(73) Assignee: SAMSUNG ELECTRONICS CO., LTD., Suwon-si (KR)

(21) Appl. No.: 13/290,240

(22) Filed: Nov. 7, 2011

(30) Foreign Application Priority Data
Dec. 17, 2010 (KR) 10-2010-0129581

(51) Int. Cl. G06K 9/64

(52) U.S. Cl. 382/149

(57) ABSTRACT

A method and apparatus for detecting a defect in a pattern are provided. The method includes: obtaining a pattern image from a pattern in a region of interest on a semiconductor substrate and obtaining a reference image are obtained; matching the obtained pattern image and the obtained reference image to select a pixel group including pixels indicating defect information of the pattern image; adjusting a defect detection threshold of the selected pixel group; comparing the obtained pattern image and the obtained reference image to detect a pattern defect in a detection region corresponding to the selected pixel group of the pattern image, according to the adjusted defect detection threshold.

### CROSS-REFERENCE TO RELATED APPLICATION

This application claims priority from Korean Patent Application No. 10-2010-0129581, filed on Dec. 17, 2010 in the Korean Intellectual Property Office (KIPO), the entire contents of which are herein incorporated by reference.

### BACKGROUND

1. Field

Exemplary embodiments relate to a method of detecting a defect in a pattern and an apparatus for performing the same. More particularly, exemplary embodiments relate to a method of detecting a defect in a pattern formed on a semiconductor substrate and an apparatus for performing the same.

2. Description of the Related Art

During manufacture of a semiconductor device, it may be necessary to precisely detect defects in fine patterns that are formed by a photolithography process, an etch process, etc. Generally, an image inspection technique using light or an electronic beam may be performed to detect a defect in a pattern. In the technique, images obtained by light or an electronic beam may be compared to inspect a defect in a pattern.

For example, images of adjacent patterns may be compared to detect a defect in an object pattern of the adjacent patterns. In this case, adjacent images may be stored, and, for example, at least three images may be compared to one another to detect a defect in the object pattern.

However, in a related art method of detecting a defect in a pattern, a noise due to color variation may be determined as a real defect. Accordingly, a method of accurately and precisely detecting a real defect in a pattern may be required.

### SUMMARY

Exemplary embodiments provide a defect detecting method capable of detecting a defect in a pattern precisely and accurately.

Exemplary embodiments provide an apparatus for performing the above method.

According to an aspect of an exemplary embodiment, there is provided a method of detecting a defect in a pattern, the method including: obtaining a pattern image from a pattern in a region of interest on a semiconductor substrate and obtaining a reference image; matching the obtained pattern image and the obtained reference image to select a pixel group including pixels indicating defect information of the pattern image; adjusting a defect detection threshold of the selected pixel group; comparing the obtained pattern image and the obtained reference image to detect a pattern defect in a detection region corresponding to the selected pixel group of the pattern image, according to the adjusted defect detection threshold.

In one or more exemplary embodiments, the matching may include selecting pixels determined to possibly indicate noise information.

In one or more exemplary embodiments, the adjusting the defect detection threshold may include adjusting defect detection thresholds of the pixels determined to possibly indicate noise information.

In one or more exemplary embodiments, pixels determined to possibly indicate real defect information may be adjusted to have a first defect detection threshold, and the pixels determined to possibly indicate noise information may be adjusted to have a second defect detection threshold different from the first defect detection threshold.

In one or more exemplary embodiments, the second defect detection threshold may be greater than the first defect detection threshold.

In one or more exemplary embodiments, the pattern in the region of interest pattern in a region of interest may have a periodic arrangement on the semiconductor substrate.

In one or more exemplary embodiments, the comparing the obtained pattern image and the obtained reference image may include obtaining a differential image between the obtained pattern image and the obtained reference image, according to the adjusted defect detection threshold.

In one or more exemplary embodiments, the comparing the obtained pattern image and the obtained reference image may be performed using gray level information of the pixels.

According to an aspect of another exemplary embodiment, there is provided an apparatus for detecting a defect in a pattern, the apparatus including: an image processing portion which obtains a pattern image from a pattern in a region of interest on a semiconductor substrate and which obtains a reference image; a pixel selection portion which matches the obtained pattern image and the obtained reference image to select a pixel group including pixels indicating defect information of the pattern image; a threshold determination portion which adjusts a defect detection threshold of the selected pixel group; and a detection portion which compares the obtained pattern image and the obtained reference image to detect a pattern defect in a detection region corresponding to the selected pixel group of the pattern image, according to the adjusted defect detection threshold.

In one or more exemplary embodiments, the pixel selection portion may further select pixels determined to possibly indicate noise information.

In one or more exemplary embodiments, the threshold determination portion may further adjust defect detection thresholds of the pixels determined to possibly indicate noise information.

In one or more exemplary embodiments, pixels determined to possibly indicate real defect information may be adjusted to have a first defect detection threshold, and the pixels determined to possibly indicate noise information may be adjusted to have a second defect detection threshold different from the first defect detection threshold.

In one or more exemplary embodiments, the second defect detection threshold may be greater than the first defect detection threshold.

In one or more exemplary embodiments, the pattern in the region of interest pattern in a region of interest may have a periodic arrangement on the semiconductor substrate.

In one or more exemplary embodiments, the detection portion may compare the obtained pattern image and the obtained reference image using gray level information of the pixels.

According to an aspect of another exemplary embodiment, there is provided a method of detecting a defect in a pattern, the method including obtaining a pattern image from a pattern in a region of interest on a semiconductor substrate and selecting a pixel group including pixels indicating defect information of the pattern image; and adjusting a defect detection threshold of the selected pixel group and detecting a pattern defect in a detection region corresponding to the selected pixel group of the pattern image, according to the adjusted defect detection threshold.

According to an aspect of another exemplary embodiment, there is provided a method of detecting a defect in a pattern, the method including: obtaining an image from a region of interest on a semiconductor substrate and obtaining a reference image; selecting, from the obtained image, a pixel group including pixels determined to possibly indicate defect information; selectively applying a defect detection threshold to the selected pixel group; and comparing the obtained image and the obtained reference image to detect a pattern defect in a detection region corresponding to the selected pixel group of the pattern image, according to the selectively applied defect detection threshold.

Accordingly, a noise region possibly indicating noise information due to a noise such as color variation may be excluded from the field of view (FOV) of a predetermined size and a desired pixel group including pixels possibly indicating real defect information may be selected, to accurately and precisely defect a real defect in a pattern.

### BRIEF DESCRIPTION OF THE DRAWINGS

Exemplary embodiments will be more clearly understood from the following detailed description taken in conjunction with the accompanying drawings. FIGS. 1 to 7B represent non-limiting, exemplary embodiments as described herein.

FIG. 1 is a block diagram illustrating an apparatus for detecting a defect in a pattern in accordance with an exemplary embodiment;

FIG. 2 is a flow chart illustrating a method of detecting a defect in a pattern in accordance with an exemplary embodiment;.

FIG. 3A is a view illustrating a pattern image of an object pattern in accordance with an exemplary embodiment;

FIG. 3B is a view illustrating a reference image for comparison with the pattern image of FIG. 3A in accordance with an exemplary embodiment;

FIG. 4 is a scanning electron microscope (SEM) image of FIG. 3A in accordance with an exemplary embodiment;

FIG. 5 represents pixel groups selected in the pattern image of FIG. 4 in accordance with an exemplary embodiment;

FIG. 6 is a view illustrating thresholds for pixels representing the pattern image in accordance with an exemplary embodiment;

FIG. 7A is a graph illustrating gray levels for pixels of a pattern image in accordance with an exemplary embodiment; and

FIG. 7B is an enlarged graph illustrating “A” portion of FIG. 7A in accordance with an exemplary embodiment.

### DETAILED DESCRIPTION OF EXEMPLARY EMBODIMENTS

Various exemplary embodiments will be described more fully hereinafter with reference to the accompanying drawings. Exemplary embodiments may, however, be embodied in many different forms and should not be construed as limited to exemplary embodiments set forth herein. Rather, these exemplary embodiments are provided so that this disclosure will be thorough and complete, and will fully convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments will be explained in detail with reference to the accompanying drawings.

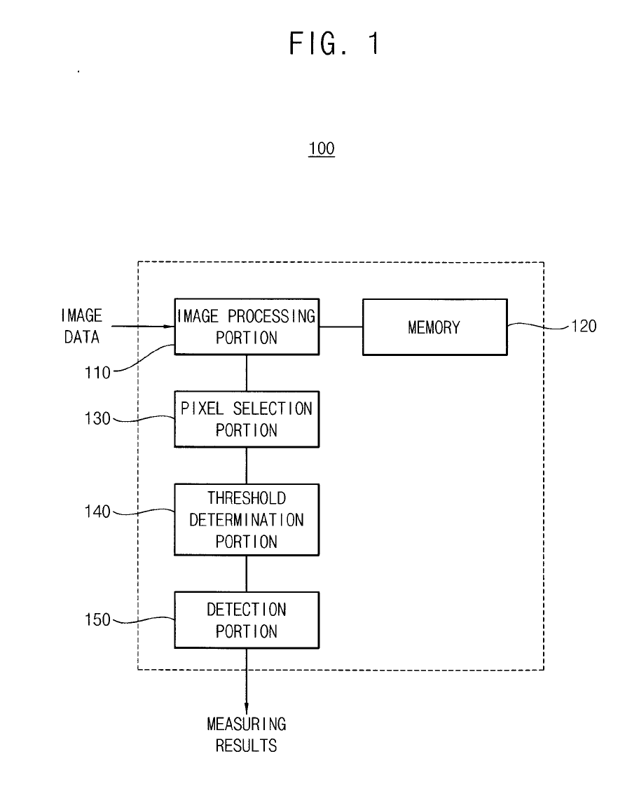

FIG. 1 is a block diagram illustrating an apparatus 100 for detecting a defect in a pattern in accordance with an exemplary embodiment.

Referring to FIG. 1, an apparatus 100 according to an exemplary embodiment may include an image processing portion 110, a memory 120, a pixel selection portion 130, a threshold determination portion 140 and a detection portion 150.

In exemplary embodiments, the image processing portion 110 may receive image data of patterns formed on a semiconductor substrate from an inspection apparatus (not illustrated) and obtain a pattern image of the pattern and a reference image from the image data.

The inspection apparatus may use light or an electron beam to obtain the image data of the patterns. Examples of the inspection apparatus may be a camera (e.g., a charge-coupled device (CCD) camera), a scanning electron microscope, etc.

The pattern may be formed in a cell region of the semiconductor substrate. The pattern may have a periodic arrangement. For example, the pattern may have regular lines or regular recesses spaced apart from one another by a predetermined distance. Accordingly, the pattern image and the reference image may be images of the cell region of the semiconductor substrate where the patterns having a periodic arrangement are formed.

The pattern image may be obtained from the pattern in a region of interest (i.e., object pattern) on the semiconductor substrate. The reference image may be an image of a cell region adjacent to the cell region for the pattern image. That is, the reference image may be obtained from a pattern of an adjacent and corresponding cell region, which is identical to the pattern in a region of interest (i.e., object pattern). Alternatively, the reference image having the same shape as the object pattern may be obtained from a die adjacent and corresponding to the object pattern. However, it is understood that another exemplary embodiment is not limited thereto. For example, according to another exemplary embodiment, the reference image may be obtained from a pattern of a corresponding cell region that is not adjacent to the cell region for the pattern image, or may be a previously stored image.

The image processing portion 110 may be connected to the memory 120 to store image data in the memory 120. Accordingly, image data for the pattern image and the reference image may be stored in the memory 120.

In exemplary embodiments, the image data may have gray levels for a plurality of pixels. The pixels may be selected by a region of interest (i.e., field of view). The pattern image and the reference image may have a specific size and pixels according to an inspection utility, a user input, an object pattern size, etc.

For example, the pattern image and the reference image may have a 512*512 pixel size or a 1024*1024 pixel size. The gray level per each pixel may range from 0 to 255. Black may be represented by gray level 0, white may be represented by gray level 255 and gray may be represented by gray level 1 to 254. Accordingly, the pixels may have respective coordinates (x, y) and the gray level information of the pixels constituting the image may be stored with a total of 256 numbers.

The pixel selection portion 130 may match the pattern image and the reference image to select at least one pixel group including pixels indicating real defect information of the pattern image.

The pattern image may have pixels having noise information due to a noise such as color variation. The pixel selection portion 130 may further select the pixels indicating noise information of the pattern image.

Accordingly, the pixel selection portion may exclude pixels possibly indicating noise information from the pattern image of a predetermined pixel size and may select a pixel group including pixels possibly indicating real defect information.

For example, the pixel selection portion 130 may select a first pixel group, a second pixel group and a third pixel group that indicate real defect information, respectively. The first, second and third pixel groups may have different pixel numbers and pixel positions. Accordingly, the selected pixel group may be a customized pixel group selected by an inspector in order to precisely inspect a region where a real defect exists in the object pattern. The selected pixel group may correspond to a detection region selected from the field of view of the object pattern.

The threshold determination portion 140 may determine a defect detection threshold of the selected pixel group (detection region). The detection portion 150 may compare the pattern image and the reference image to detect a pattern defect in the detection region (corresponding to the pixel group) of the pattern image.

The thresholds for all pixels representing the pattern image may be set to a predetermined initial value. The threshold determination portion 140 may adjust the pixels of the selected pixel group to a specific value different from the initial value. The threshold determination portion 140 may further adjust the pixels possibly indicating noise information to another value.

For example, the pixels possibly indicating real defect information may be adjusted to have a first defect detection threshold, and the pixels possibly indicating noise information may be adjusted to have a second defect detection threshold greater than the first defect detection threshold. However, it is understood that one or more other exemplary embodiments are not limited thereto. For example, according to another exemplary embodiment, the pixels possibly indicating real defect information may be maintained to have the predetermined initial value, while the pixels possibly indicating noise information may be adjusted to have a defect detection threshold greater than the predetermined initial value.

The detection portion 150 may compare the pattern image and the reference image to generate a differential image. Because the thresholds for the pixels possibly indicating noise information are selectively adjusted, the differential image may indicate only real defect information.

Accordingly, the detection portion 150 may detect a pattern defect in the detection region corresponding to the pixel group with a high sensitivity, compared with a region other than the detection region.

In an exemplary embodiment, the detection portion 150 may calculate a correlation between a gray level per each pixel of the pattern image and a gray level per each pixel of the reference image. The correlation may have an x-axis position correlation and a y-axis position correlation. The correlation may depend on a similarity of gray levels between the compared pixels. For example, the correlation may be close to 1 when the gray level difference between the compared pixels is relatively small, and the correlation may be close to 0 when the gray level difference between the compared pixels is relatively great. In addition, a predetermined correlation may be a value between 0 and 1.

Whether there is a defect in the pattern image may be determined based on the calculated correlation and the predetermined correlation.

Hereinafter, a method of detecting a defect in a pattern using the apparatus 100 in FIG. 1 will be explained in detail.

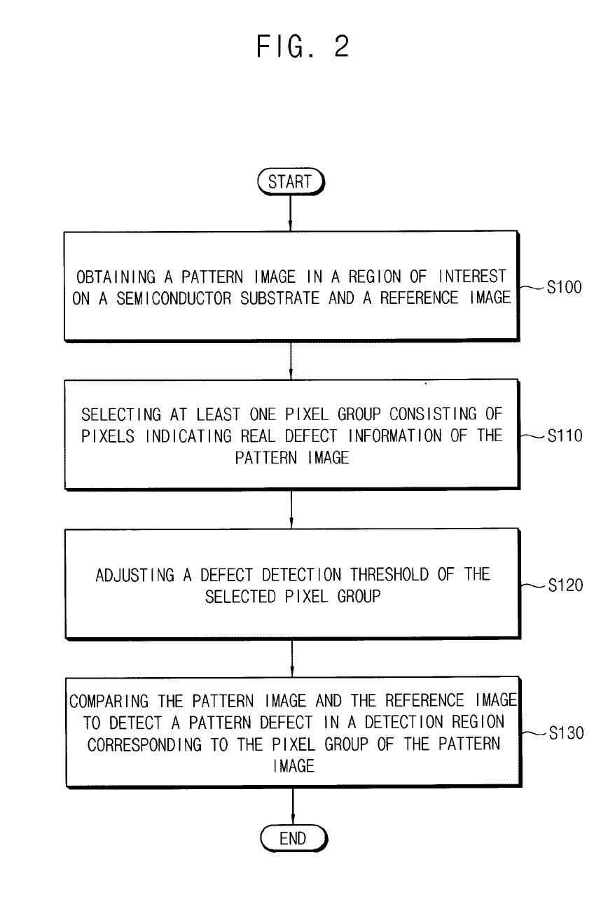

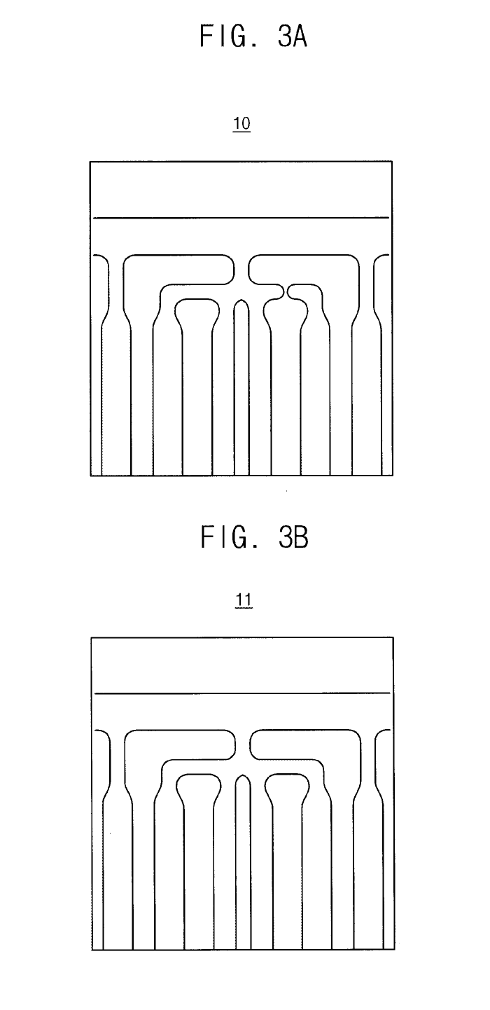

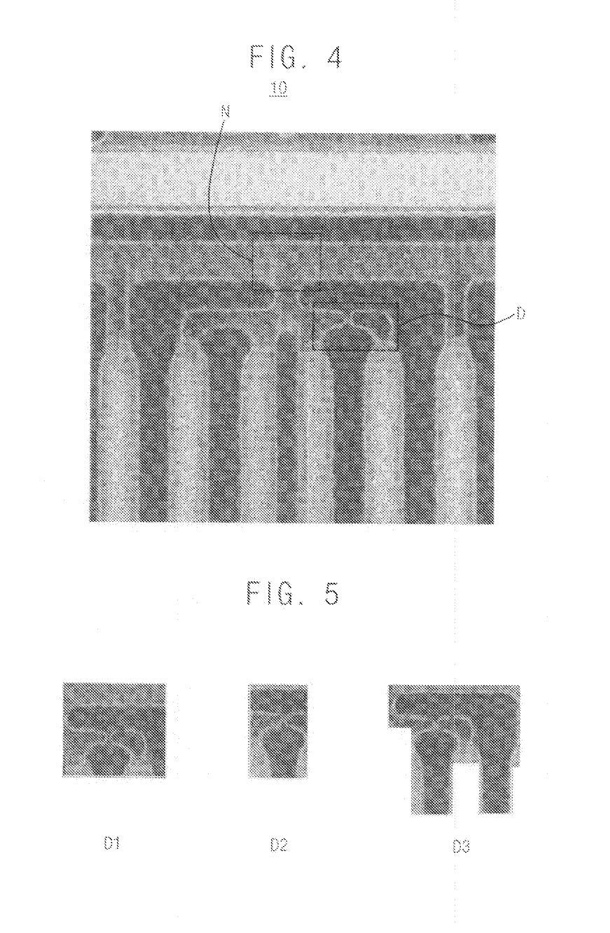

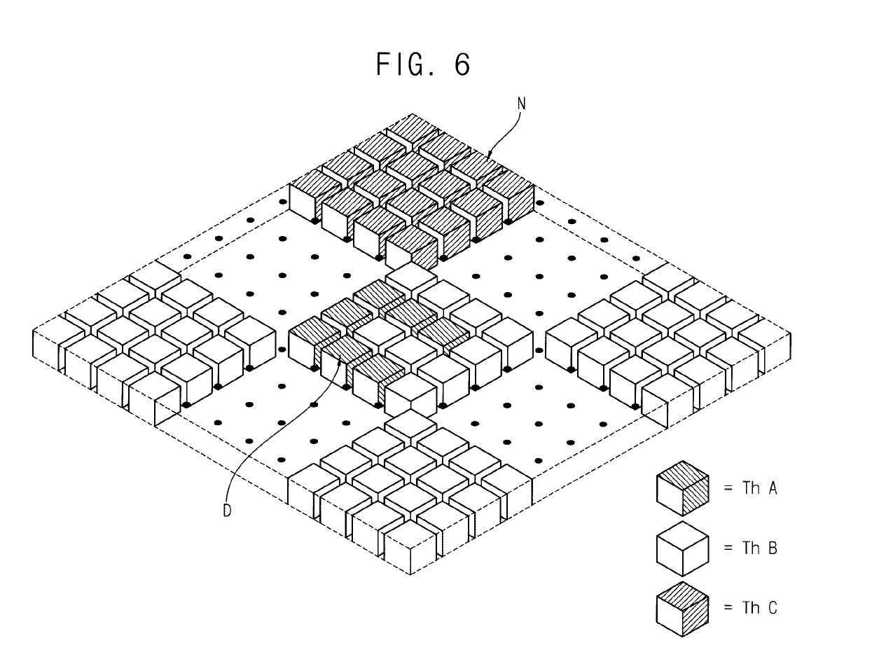

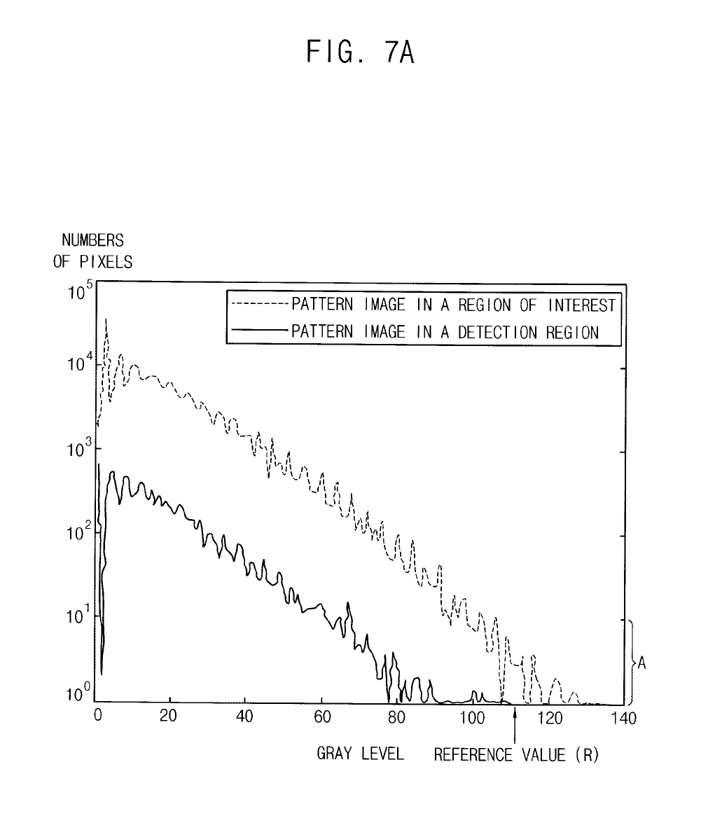

FIG. 2 is a flow chart illustrating a method of detecting a defect in a pattern in accordance with an exemplary embodiment. FIG. 3A is a view illustrating a pattern image of an object pattern in accordance with an exemplary embodiment. FIG. 3B is a view illustrating a reference image for comparison with the pattern image of FIG. 3A in accordance with an exemplary embodiment. FIG. 4 is a scanning electron microscope (SEM) image of FIG. 3A in accordance with an exemplary embodiment. FIG. 5 represents pixel groups selected in the pattern image of FIG. 4 in accordance with an exemplary embodiment. FIG. 6 is a view illustrating thresholds for pixels representing the pattern image in accordance with an exemplary embodiment.

Referring to FIGS. 1 to 6, a pattern image 10 and a reference image 11 may be obtained (operation S100). The pattern image may be obtained from the pattern in a region of interest (i.e., object pattern) on the semiconductor substrate.

First, a substrate having a pattern formed thereon may be prepared. For example, the substrate may be a semiconductor substrate such as a wafer. The pattern may be formed in a cell region of the semiconductor substrate. The pattern may have a periodic arrangement. For example, the pattern may have regular lines or regular recesses spaced apart from one another by a predetermined distance.

In an exemplary embodiment, a scanning electron microscope (not illustrated) may irradiate and scan primary electrons onto the substrate and detect secondary electrons from the substrate to obtain an image data of the pattern.

In this case, the secondary electrons are electrons ionized from atoms in the substrate by the primary electrons. The secondary electrons may have different energies according to at least one of the surface of the substrate and the shape of the pattern. For example, the secondary electron may have a higher energy on an inclined surface than on an upper surface of the pattern. In addition, the secondary electron may have a higher energy on an edge portion facing with the substrate than the inclined surface of the pattern.

The secondary electrons having different energies may be detected to generate signals having different currents, and the generated signals may be amplified and transformed to form image data of the pattern.

Then, the image processing portion 110 of FIG. 1 may obtain the pattern image 10 of FIG. 3A and the reference image 11 of FIG. 3B from the image data of the pattern.

For example, the pattern image 10 may be obtained from the pattern in a region of interest (i.e., object pattern) on the semiconductor substrate. The reference image 11 may be an image of a cell region adjacent to the cell region for the pattern image. That is, the reference image may be obtained from a pattern of the adjacent and corresponding cell region, which is identical to the pattern in a region of interest (i.e., the object pattern). Alternatively, the reference image having the same shape as the object pattern may be obtained from a die adjacent and corresponding to the object pattern.

Accordingly, the pattern image and the reference image may be images of the cell region of the semiconductor substrate where the patterns having a periodic arrangement are formed.

Then, image data for the pattern image 10 and the reference image 11 may be stored in the memory 120 of FIG. 1.

In exemplary embodiments, the image data may have gray levels for a plurality of pixels corresponding to the region of interest (i.e., field of view) on the semiconductor substrate. The pattern image and the reference image may have specific sizes and pixels according to an inspection utility.

As illustrated in FIG. 4, the pattern image 10 and the reference image 11 may have a predetermined pixel size (i.e., field of view), respectively. For example, the pattern image may have a 512*512 pixel size or a 1024*1024 pixel size. The pixels may have respective coordinates (x, y) and gray level information of the pixels constituting the image may be stored with a total of 256 numbers.

The pattern image and the reference image may be matched to select at least one pixel group including pixels indicating real defect information of the pattern image (operation S110).

Referring to FIGS. 4 to 6, the pattern image 10 may include a region (D) of pixels indicating real defect information within the field of view (FOV). Also, the pattern image 10 may include a noise region (N) of pixels indicating noise information due to a noise, such as color variation, that occurs when comparing the pattern image 10 and the reference image 11. When the pattern image 10 is compared with the reference image 11, the noise region (N) may be detected as noise.

Accordingly, the noise region (N) possibly indicating noise information may be excluded from the pattern image and the pixel group (D) including pixels possibly indicating real defect information may be selected. Accordingly, the selected pixel group (D) may be a customized pixel group selected by an inspector in order to precisely inspect a region where a real defect exists in the object pattern. The selected pixel group may correspond to a detection region selected from the field of view (FOV) of the object pattern.

As illustrated in FIG. 5, in an exemplary embodiment, a plurality of pixel groups may be selected. For example, the inspector may select a first pixel group (D1), a second pixel group (D2) and a third pixel group (D3) that indicate real defect information, respectively. The first, second and third pixel groups may have different pixel numbers and pixel positions.

After a defect detection threshold of the selected pixel group (D) is adjusted (operation S120), the pattern image 10 and the reference image 11 may be compared to detect a pattern defect in the detection region corresponding to the pixel group (D) of the pattern image 10 (operation S130).

As illustrated in FIG. 6, the inspector may determine a defect detection threshold of the selected pixel group (D). The pixels of the selected pixel group (D) may be adjusted to have a specific threshold value different from an initial value and the pixels of the noise region (N) may be adjusted to have a specific threshold value different from an initial value.

For example, the thresholds for all the pixels representing the pattern image 10 may be set to a predetermined initial value (Th B). The pixel group (D) possibly indicating real defect information may be adjusted to have a first defect detection threshold (Th A), and the pixel group (N) possibly indicating noise information may be adjusted to have a second defect detection threshold (Th C) greater than the first defect detection threshold (Th A).

Then, the pattern image 10 and the reference image 11 may be differentially compared to detect a defect in the detection region.

The detection portion 150 in FIG. 1 may compare the pattern image and the reference image to generate a differential image. Because the thresholds for the pixels possibly indicating noise information are selectively adjusted to be excluded, the differential image may indicate only real defect information.

In an exemplary embodiment, only the selected pixel group (D) of the pattern image may be compared with a corresponding portion of the reference image. The detection region corresponding to the selected pixel group (D) may be selected and provided for comparison with the reference image. Accordingly, a pattern defect in the detection region corresponding to the selected pixel group (D) may be detected with a high sensitivity, compared with a region other than the detection region.

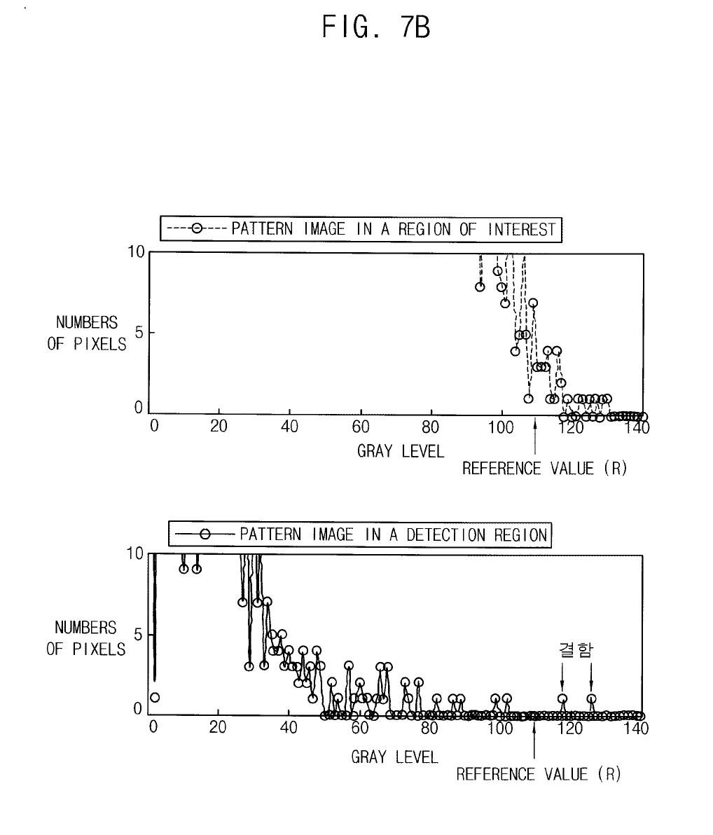

FIG. 7A is a graph illustrating gray levels for pixels of a pattern image in accordance with an exemplary embodiment. FIG. 7B is an enlarged graph illustrating “A” portion of FIG. 7A. In FIGS. 7A and 7B, the dotted line represents gray levels for pixels in a region of interest of the pattern image and the solid line represents gray levels for pixels in a detection region of the pattern image.

Referring to FIGS. 7A and 7B, the detection portion 150 of FIG. 1 may determine the coordinates having gray levels greater than a reference value (R) as a defect position. That is, some pixels of all the pixels in the region of interest of the pattern image may have gray levels greater than a reference valve (R) due to a noise, and thus, may be determined as defects even though they are not real defects.

Pixels of the selected pixel group (D) may correspond to a detection region where noise information is excluded. Accordingly, the pixels in the detection region of the pattern image may have gray levels indicating only real defects. As illustrated in FIG. 7B, the coordinates of pixels in a detection region of the pattern image having gray levels greater than a reference value (R) may represent a real defect position. Accordingly, a defect in a pattern on a semiconductor substrate may be accurately detected.

A series of operations of a method of detecting a defect in a pattern according to exemplary embodiments may be programmed on a non-transitory computer readable medium such as CD-ROM, a read-only memory (ROM), a random-access memory (RAM), a magnetic tape, a floppy disk, and an optical data storage device, and/or may be executed by a computer. The computer readable recording medium can also be distributed over network-coupled computer systems so that the computer readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. The method of detecting a defect in a pattern may be realized using an image processing computer. Moreover, one or more units of the apparatus 100 for detecting a defect in a pattern and the image processing computer can include a processor or microprocessor executing a computer program stored in a computer readable medium.

As mentioned above, in a method of detecting a defect in a pattern in accordance with exemplary embodiments, a pattern image from a pattern in a region of interest on a semiconductor substrate may be obtained and at least one pixel group including pixels indicating real defect information of the pattern image may be selected. A defect detection threshold of the selected pixel group is adjusted, and then, a pattern defect may be detected in a detection region corresponding to the pixel group of the pattern image.

Accordingly, a noise region possibly indicating noise information due to a noise such as color variation may be excluded from the field of view (FOV) of a predetermined size and a desired pixel group including pixels possibly indicating real defect information may be selected, to accurately and precisely detect a real defect in a pattern.

The foregoing is illustrative of exemplary embodiments and is not to be construed as limiting thereof. Although a few exemplary embodiments have been described, those skilled in the art will readily appreciate that many modifications are possible in exemplary embodiments without materially departing from the novel teachings and advantages of the present inventive concept. Accordingly, all such modifications are intended to be included within the scope of exemplary embodiments as defined in the claims. In the claims, means-plus-function clauses are intended to cover the structures described herein as performing the recited function and not only structural equivalents but also equivalent structures. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A method of detecting a defect in a pattern, the method comprising:
obtaining a pattern image from a pattern in a region of interest on a semiconductor substrate and obtaining a reference image;
matching the obtained pattern image and the obtained reference image to select a pixel group comprising pixels indicating defect information of the pattern image;
adjusting a defect detection threshold of the selected pixel group; and
comparing the obtained pattern image and the obtained reference image to detect a pattern defect in a detection region corresponding to the selected pixel group of the pattern image, according to the adjusted defect detection threshold.

2. The method of claim 1, wherein the matching comprises selecting pixels determined to possibly indicate noise information.

3. The method of claim 2, wherein the adjusting the defect detection threshold comprises adjusting defect detection thresholds of the pixels determined to possibly indicate noise information.

4. The method of claim 3, wherein pixels determined to possibly indicate real defect information are adjusted to have a first defect detection threshold, and the pixels determined to possibly indicate noise information are adjusted to have a second defect detection threshold different from the first defect detection threshold.

5. The method of claim 4, wherein the second defect detection threshold is greater than the first defect detection threshold.

6. The method of claim 1, wherein the pattern in the region of interest has a periodic arrangement on the semiconductor substrate.

7. The method of claim 1, wherein the comparing the obtained pattern image and the obtained reference image comprises obtaining a differential image between the obtained pattern image and the obtained reference image, according to the adjusted defect detection threshold.

8. The method of claim 1, wherein the comparing the obtained pattern image and the obtained reference image is performed using gray level information of the pixels.

9. The method of claim 1, wherein the matching comprises selecting a plurality of pixel groups comprising the pixels indicating the defect information of the pattern image.

10. An apparatus for detecting a defect in a pattern, the apparatus comprising:
an image processing portion which obtains a pattern image from a pattern in a region of interest on a semiconductor substrate and which obtains a reference image;
a pixel selection portion which matches the obtained pattern image and the obtained reference image to select a pixel group comprising pixels indicating defect information of the pattern image;
a threshold determination portion which adjusts a defect detection threshold of the selected pixel group; and
a detection portion which compares the obtained pattern image and the obtained reference image to detect a pattern defect in a detection region corresponding to the selected pixel group of the pattern image, according to the adjusted defect detection threshold.

11. The apparatus of claim 10, wherein the pixel selection portion further selects pixels determined to possibly indicate noise information.

12. The apparatus of claim 11, wherein the threshold determination portion further adjusts defect detection thresholds of the pixels determined to possibly indicate noise information.

13. The apparatus of claim 12, wherein pixels determined to possibly indicate real defect information are adjusted to have a first defect detection threshold, and the pixels determined to possibly indicate noise information are adjusted to have a second defect detection threshold different from the first defect detection threshold.

14. The apparatus of claim 13, wherein the second defect detection threshold is greater than the first defect detection threshold.

15. The apparatus of claim 10, wherein the pattern in the region of interest has a periodic arrangement on the semiconductor substrate.

16. A method of detecting a defect in a pattern, the method comprising:
obtaining an image from a region of interest on a semiconductor substrate and obtaining a reference image;
selecting, from the obtained image, a pixel group comprising pixels determined to possibly indicate defect information;
selectively applying a defect detection threshold to the selected pixel group; and
comparing the obtained image and the obtained reference image to detect a pattern defect in a detection region corresponding to the selected pixel group of the pattern image, according to the selectively applied defect detection threshold.

17. The method of claim 16, wherein the defect detection threshold is different from a predetermined detection threshold initially set for all pixels of the obtained image.

18. The method of claim 17, wherein the selectively applying the defect detection threshold comprises applying the defect detection threshold to pixels, of the selected pixel group, determined to possibly indicate noise information.

19. A computer readable recording medium having recorded thereon a program executable by a computer for performing the method of claim 1.

20. A computer readable recording medium having recorded thereon a program executable by a computer for performing the method of claim 16.
